(19) United States
(12) Patent Application Publication
(10) Pub. No.: US 2026/0176713 A1
(43) Pub. Date: Jun. 25, 2026

(54) METHOD FOR ISOLATING TRANSITION METAL AND LI FROM COMPOUND INCLUDING LI AND TRANSITION METAL

(71) Applicant: PANASONIC ENERGY CO., LTD., Moriguchi-shi, Osaka (JP)

(72) Inventor: Toshinobu Kanai, Hyogo Ken (JP)

(73) Assignee: Panasonic Energy co., Ltd., Moriguchi-shi, Osaka (JP)

(21) Appl. No.: 19/123,157

(22) PCT Filed: Oct. 13, 2023
(86) PCT No.: PCT/JP2023/037239

§ 371 Date: Apr. 22, 2025

(30) Foreign Application Priority Data
Oct. 31, 2022 (JP) 2022-174793

(51) Int. Cl. C22B 3/06; B01J 39/07; B01J 41/07; C22B 3/00; C22B 3/24; C22B 26/12

(52) U.S. Cl. CPC C22B 3/06; B01J 39/07; B01J 41/07; C22B 3/24; C22B 23/0415; C22B 26/12; C01P 2002/70; C01P 2004/61

(57) ABSTRACT

A method for separating a transition metal and Li includes a step of allowing a compound containing Li and a transition metal to react with a carboxylic acid in water, to obtain a slurry containing a first solution containing Li ions and a precipitate containing a transition metal carboxylate, and a step of separating the precipitate from the first solution. The transition metal is at least one selected from the group consisting of Ni, Co, Mn, Ti, Fe, and Cu.

### CROSS REFERENCE TO RELATED APPLICATION

The present disclosure claims priority with respect to the Japanese Patent Application No. 2022-174793 filed on Oct. 31, 2022, and the entire content of the patent application is incorporated herein by reference into the present specification.

### TECHNICAL FIELD

The present disclosure relates to a method for separating a transition metal and Li from a compound containing Li and the transition metal.

### BACKGROUND ART

From the viewpoint of protecting the global environment, environmentally friendly “monozukuri, or manufacturing” in various indicators has been demanded. In the production of lithium-ion secondary batteries, too, legal regulations regarding the carbon footprint (CFP) reduction and the usage rate of recycled materials have been established in Europe's regions. This movement would influence the United States and China as well. Especially, the positive electrode material of lithium-ion secondary batteries is constituted mainly of rare metals, such as Ni, Co, and Li, and it is desired to recycle them to be reused as raw materials of the positive electrode material.

For example, in the case of recycling black mass (crushed electrode material), from the viewpoint of CFP, employing hydrometallurgy, rather than pyrometallurgy, has been the mainstream (Patent Literatures 1 to 3).

### CITATION LIST

### Patent Literature

Patent Literature 1: Japanese Laid-Open Patent Publication No. 2016-186113
Patent Literature 2: Japanese Laid-Open Patent Publication No. 2016-186118
Patent Literature 3: Japanese Laid-Open Patent Publication No. 2021-504885

### SUMMARY OF INVENTION

### Technical Problem

In the conventional hydrometallurgical processing, lithium is recovered as Li₂CO₃, and sodium sulfate is produced as a by-product. Such a process is low in economic rationality and is a process not suitable for recycling.

### Solution to Problem

One aspect of the present disclosure relates to a method for separating a transition metal and Li, including: a step of allowing a compound containing Li and a transition metal to react with a carboxylic acid in water, to obtain a slurry containing a first solution containing Li ions and a precipitate containing a transition metal carboxylate; and a step of separating the precipitate from the first solution, wherein the transition metal is at least one selected from the group consisting of Ni, Co, Mn, Ti, Fe, and Cu.

### Advantageous Effects of Invention

According to the present disclosure, it is possible to improve the economic rationality in the method for separating a transition metal and Li from a compound containing Li and the transition metal.

While the novel features of the invention are set forth particularly in the appended claims, the invention, both as to organization and content, will be better understood and appreciated, along with other objects and features thereof, from the following detailed description taken in conjunction with the drawings.

### BRIEF DESCRIPTION OF DRAWING

FIG. 1 A flowchart of the procedure of a method for separating a transition metal and Li according to one embodiment of the present disclosure.

### DESCRIPTION OF EMBODIMENTS

Embodiments of the present disclosure will be described below by way of examples, but the present disclosure is not limited to the examples described below. In the following description, specific numerical values and materials are exemplified in some cases, but other numerical values and other materials may be adopted as long as the effects of the present disclosure can be obtained. For the components other than those characteristic of the present disclosure, any known components may be adopted. In the present specification, when referring to “a range of a numerical value A to a numerical value B,” the range includes the numerical value A and the numerical value B.

In the following description, when the lower and upper limits of numerical values related to specific physical properties, conditions, etc. are mentioned as examples, any one of the mentioned lower limits and any one of the mentioned upper limits can be combined in any combination as long as the lower limit is not equal to or more than the upper limit. When a plurality of materials are mentioned as examples, unless otherwise mentioned, one kind of them may be selected and used singly, or two or more kinds of them may be used in combination.

The present disclosure encompasses a combination of matters recited in any two or more claims selected from plural claims in the appended claims. In other words, as long as no technical contradiction arises, matters recited in any two or more claims selected from plural claims in the appended claims can be combined.

A method for separating a transition metal and Li (hereinafter sometimes referred to as a “separation method (ML)”) according to one embodiment of the present disclosure has at least the following three steps. According to the separation method (ML), a transition metal carboxylate and a solution containing Li ions are obtained. Therefore, the separation method (ML) is a method for producing a transition metal carboxylate, and a method for producing a solution containing Li ions, as well. Hereinafter, the transition metal is sometimes denoted by “M”.

### <First Step>

The first step is a step of allowing a compound containing Li and a transition metal (hereinafter sometimes referred to as a “LiM-containing compound”) to react with a carboxylic acid in water, to obtain a first solution containing Li ions and a precipitate containing a transition metal carboxylate. Using a carboxylic acid for the reaction with a LiM-containing compound produces some merits that cannot be obtained when using an inorganic acid, such as sulfuric acid and nitric acid. The first merit is that, since carboxylic acids are weak acids, corrosion of equipment is less likely occur than when using an inorganic acid.

The carboxylic acid may be used in the form of an aqueous carboxylic acid solution. Although the concentration of the aqueous carboxylic acid solution is not particularly limited, for example, using the carboxylic acid in the form of an aqueous carboxylic acid solution having a concentration of 0.2 mol/L to 0.6 mol/L is desirable in terms of increasing the utilization rate of the carboxylic acid and enhancing the reactivity with the LiM-containing compound. In other words, in the step of obtaining a slurry, it is desirable to add an aqueous carboxylic acid solution having a carboxylic acid concentration of 0.2 mol/L to 0.6 mol/L, to the LiM-containing compound in water.

In view of facilitating the formation of a precipitate containing a transition metal carboxylate, the pH of the first solution is desirably adjusted to 5 or less. When the pH of the first solution is further increased, the transition metal carboxylate will dissolve gradually, tending to lower the efficiency of the separation. The pH of the first solution may be adjusted to 0.5 or more and 5 or less, and may be adjusted to 1 or more and 5 or less, or 3 or more and 5 or less.

When the LiM-containing compound is, for example, LiMO₂, and the carboxylic acid is, for example, formic acid, it is presumed that the reactions as below proceed. The reactions proceed accompanied by the generation of hydrogen gas, and a formate of M is formed from LiMO₂. However, the following reaction formulas are one example, and a reaction not following the reaction formulas below may proceed.

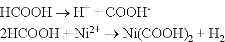

It is desirable that the precipitate containing a transition metal carboxylate is allowed to precipitate so that the median diameter at 50% cumulative volume in a volume-based particle size distribution (hereinafter, “D50”) reaches 4 μm or more, or further reaches 6 μm or more. By this, in the subsequent second step (filtration), the filtration performance can be improved, leading to improved efficiency of the separation.

In order to generate a precipitate with an appropriate D50, in the step of obtaining a slurry, it is desirable to allow the precipitation to proceed while the LiM-containing compound is stirred in water at 90° C. or less. With a higher water temperature (i.e., the reaction temperature), the D50 tends to decrease. From a similar point of view, in the step of obtaining a slurry, it is desirable to allow a precipitate to precipitate while the LiM-containing compound is stirred at 200 to 500 rpm in water.

The LiM-containing compound may be an electrode material recovered from a secondary battery. As the LiM-containing compound, for example, a crushed electrode material called black mass may be used. In this case, the black mass may be mixed with a carboxylic acid in water.

The secondary battery containing a LiM-containing compound as an electrode material can be a lithium-ion secondary battery, a lithium-metal secondary battery, an all-solid-state battery, and the like. For example, the electrode material can be recovered by subjecting the secondary battery to a predetermined treatment, and then crushed, followed by magnetic separation or sieve separation.

The secondary battery may be, for example, a used secondary battery disposed of at the end of product life and collected, which has been used in vehicles, or a home appliance or a laptop computer, and the like. Alternatively, it may be a defective secondary battery that has occurred during the manufacturing process. The shape of the secondary battery is not particularly limited. For example, a secondary battery of a cylindrical type, a prismatic type, a button type, a coin type, a pouch type, or the like may be used.

The composite metal compound that can be used as a LiM-containing compound can include a composite metal oxide, a composite metal sulfide, a composite metal fluoride, a composite metal hydrogenfluoride, a composite metal polyanion compound, and the like. The crystal structure of the composite metal compound is not particularly limited, examples of which include layered rock-salt type, spinel type, olivine type, and perovskite type structures.

In particular, the method according to the present disclosure is useful when the composite metal compound is a composite metal oxide. Therefore, the major component of the LiM-containing compound is desirably a composite metal oxide. The major component of the composite metal oxide is, for example, a composite metal oxide that occupies 50 mass % or more, further 60 mass % or more, or 70 mass % or more, or 80 mass % or more of the LiM-containing compound.

The transition metal M includes at least one selected from the group consisting of Ni, Co, Mn, Ti, Fe, and Cu. In particular, the method according to the present disclosure is useful when the ratio of Ni in the metal elements other than Li in the composite metal compound is high. The ratio of Ni in the metal elements other than Li in the composite metal compound may be 50 atom % or more, may be 60 atom % or more, may be 70 atom % or more, and may be 80 atom % or more.

The LiM-containing compound may be a composite metal compound containing Ni and a transition metal other than Ni. The composite metal oxide may further contain, in addition to Ni, a third metal of at least one selected from the group consisting of Fe, Ti, Co, and Mn. In this case, the third metal can be separated together with Ni from Li.

The carboxylic acid may be aliphatic or aromatic. Examples of the carboxylic acid include formic acid, acetic acid, propionic acid, butyric acid, isobutyric acid, valeric acid, caproic acid, enanthic acid, caprylic acid, pelargonic acid, lauric acid, myristic acid, stearic acid, behenic acid, acrylic acid, methacrylic acid, oleic acid, benzoic acid, cinnamic acid, naphthoic acid, salicylic acid, mandelic acid, resorcylic acid, maleic acid, phthalic acid, pyromellitic acid, resorcylic acid, succinic acid, glutaric acid, adipie acid, oxalic acid, maleic acid, fumaric acid, tartaric acid, and citric acid.

### <Second Step>

The second merit of using a carboxylic acid for dissolution of the LiM-containing compound is that a transition metal carboxylate can be obtained in a state separated from Li ions. The transition metal carboxylate, for example, when dissolved with an inorganic acid, can be recycled as a raw material for a fresh electrode material (positive electrode active material). On the other hand, most of the Li ions are separated in a dissolved state in the first solution that does not contain inorganic acid anions, such as sulfuric acid ions and nitric acid ions.

The second step is a step of separating the precipitate from the first solution. For example, the precipitate may be filtered and separated, so that the first solution, which is a filtrate, is separated from the precipitate. At this time, most of the transition metal is contained in the precipitate, and most of the Li ions are dissolved in the first solution. The third merit of using a carboxylic acid for dissolution of the LiNi-containing compound is that almost all Li ions can be easily separated as the first solution by filtration. Furthermore, the fourth merit is that the first solution is free of inorganic acid anions. In other words, there is no generation of by-product, such as sulfate and nitrate.

The obtained transition metal carboxylate includes nickel carboxylate, cobalt carboxylate, manganese carboxylate, titanium carboxylate, and the like. By dissolving these salts in a sulfuric acid, to remove carboxylic acid anions, sulfates can be obtained. For example, nickel sulfate, cobalt sulfate, manganese sulfate, or the like is useful as a raw material for an electrode material (positive electrode active materials).

### <Third Step>

The separation method (ML) may further include a step of purifying the first solution with an ion-exchange resin, to obtain a high-concentration Li solution. Since Li ions are not adsorbed to a cation-exchange resin, the Li ion concentration can be increased simply by passing the first solution through a cation-exchange resin. Moreover, since no inorganic strong acid, such as sulfuric acid and nitric acid, is used, it is possible to remove carboxylic acid anions by passing the first solution through an anion-exchange resin. By using a cation-exchange resin and an anion-exchange resin, a concentrated lithium hydroxide solution can be obtained. Then, by drying the concentrated lithium hydroxide solution, LiOH H₂O can be obtained. The ion-exchange resin is recyclable. Therefore, LiOH H₂O can be obtained at low cost. LiOH·H₂O is useful as a raw material for an electrode material (positive electrode active material).

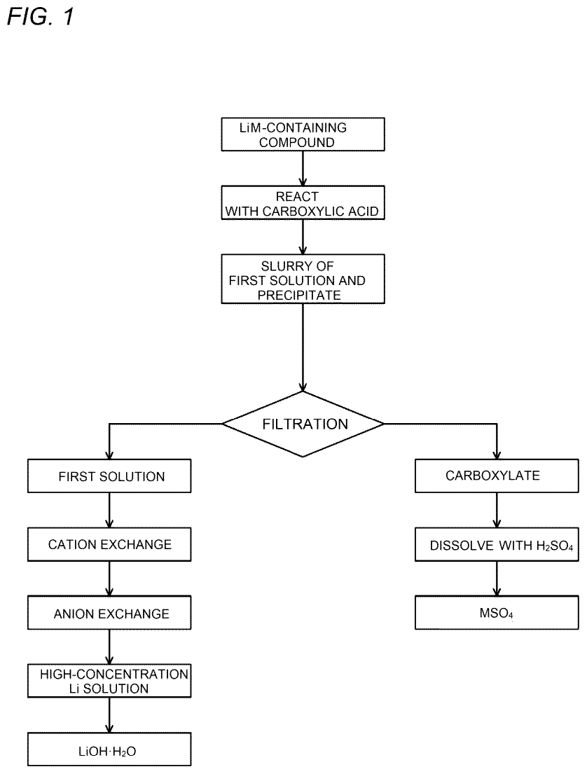

FIG. 1 is a flow diagram of the separation method (ML) of a transition metal and Li, which summarizes the above-mentioned first to third steps.

According to the separation method (ML), a Li recovery rate as a percentage expressed by C1×100 can be as high as 85% or more, further 90% or more, or 93% or more, where the C1 is a value obtained by dividing a Li amount in the first solution by the sum of the Li amount in the first solution and a Li amount in the precipitate.

According to the separation method (ML), a transition metal recovery rate as a percentage expressed by C2×100 can be as high as 80% or more, further 85% or more or 90% or more, where the C2 is a value obtained by dividing a transition metal amount in the precipitate by the sum of a transition metal amount in the first solution and the transition metal amount in the precipitate.

The Li amount and the transition metal amount in the first solution and the precipitate can be measured by inductively coupled plasma (ICP) analysis.

### <Supplementary Notes>

The above description discloses the following techniques.

### (Technique 1)

A method for separating a transition metal and Li, comprising:
a step of allowing a compound containing Li and a transition metal to react with a carboxylic acid in water, to obtain a slurry containing a first solution containing Li ions and a precipitate containing a transition metal carboxylate; and
a step of separating the precipitate from the first solution, wherein
the transition metal is at least one selected from the group consisting of Ni, Co, Mn, Ti, Fe, and Cu.

### (Technique 2)

The method for separating a transition metal and Li according to technique 1, wherein a pH of the first solution is 5 or less.

### (Technique 3)

The method for separating a transition metal and Li according to technique 1 or 2, wherein the precipitate is allowed to precipitate so that a median diameter at 50% cumulative volume in a volume-based particle size distribution reaches 4 μm or more.

### (Technique 4)

The method for separating a transition metal and Li according to any one of techniques 1 to 3, wherein in the step of obtaining a slurry, the precipitate is allowed to precipitate while the compound containing Li and a transition metal is stirred at 200 to 500 rpm, in water at 90° C. or less.

### (Technique 5)

The method for separating a transition metal and Li according to any one of techniques 1 to 4, wherein in the step of obtaining a slurry, the carboxylic acid is added, in a form of an aqueous carboxylic acid solution having a concentration of 0.2 mol/L to 0.6 mol/L, to the compound containing Li and a transition metal in the water.

### (Technique 6)

The method for separating a transition metal and Li according to any one of techniques 1 to 5, wherein the compound containing Li and a transition metal is a composite metal oxide containing Li and a transition metal.

### (Technique 7)

The method for separating a transition metal and Li according to any one of techniques 1 to 6, wherein the compound containing Li and a transition metal is an electrode material recovered from a secondary battery.

### (Technique 8)

The method for separating a transition metal and Li according to any one of techniques 1 to 7, further comprising a step of purifying the first solution with an ion-exchange resin, to obtain a high-concentration Li solution.

### (Technique 9)

The method for separating a transition metal and Li according to any one of techniques 1 to 8, wherein formic acid is used as the carboxylic acid.

### (Technique 10)

The method for separating a transition metal and Li according to any one of techniques 1 to 9, wherein a Li recovery rate as a percentage expressed by C1×100 is 85% or more, where the C1 is a value obtained by dividing an Li amount in the first solution by a sum of the Li amount in the first solution and a Li amount in the precipitate.

### (Technique 11)

The method for separating a transition metal and Li according to any one of techniques 1 to 10, wherein a transition metal recovery rate as a percentage expressed by C2×100 is 80% or more, where the C2 is a value obtained by dividing a transition metal amount in the precipitate by a sum of a transition metal amount in the first solution and the transition metal amount in the precipitate.

Although the present invention has been described in terms of the presently preferred embodiments, it is to be understood that such disclosure is not to be interpreted as limiting. Various alterations and modifications will no doubt become apparent to those skilled in the art to which the present invention pertains, after having read the above disclosure. Accordingly, it is intended that the appended claims be interpreted as covering all alterations and modifications as fall within the true spirit and scope of the invention.

### EXAMPLES

The present invention will be more specifically described below with reference to Examples and Comparative Examples. The present invention, however, is not limited to the following Examples.

### Example 1

### «First Step»

LiNi_{0.8}Co_{0.1}Mn_{0.1}O₂ was prepared as the LiM-containing compound. In 100 mL of water, 10 g of LiNi_{0.8}Co_{0.1}Mn_{0.1}O₂ was fed and stirred, to be dispersed. The stirring speed and the water temperature were controlled as shown in Table 1. Then, an aqueous formic acid solution having a concentration of 0.3 mol/L was dropped into the dispersion until pH=3, to allow LiNi_{0.8}Co_{0.1}Mn_{0.1}O₂ to react with formic acid, thereby to prepare a slurry containing a first solution containing Li ions and a precipitate.

### <Second Step>

Next, the precipitate was separated from the first solution (filtrate) by suction filtration. The precipitate was analyzed by X-ray diffraction (XRD) analysis. The result confirmed the formation of nickel formate as a major component. The D50 of the obtained precipitate was 5.3 μm, which was sufficiently large, indicating that the filterability was favorable.

### [Evaluation]

The amounts of Li, Ni, and Co in the first solution and those in the precipitate were analyzed by inductively coupled plasma (ICP) analysis.

The Li recovery rate expressed by C1×100(%) was determined, where the C1 is a value obtained by dividing a Li amount in the first solution by the sum of the Li amount in the first solution and a Li amount in the precipitate.

The Ni recovery rate expressed by C21×100(%) was determined, where the C21 is a value obtained by dividing a Ni amount in the precipitate by the sum of a transition metal amount in the first solution and the Ni amount in the precipitate.

The Co recovery rate expressed by C22×100(%) was determined, where the C22 is a value obtained by dividing a Co amount in the precipitate by the sum of a Co amount in the first solution and the Co amount in the precipitate.

The results are shown in Table 1. In the Table 1 below, A1 corresponds to Example 1, and A2 to A5 correspond to Examples 2 to 5 described later. BI corresponds to Comparative Example 1 described later.

TABLE 1

| | | | slurry preparation conditions | | | | | M | | Li |
|---|---|---|---|---|---|---|---|---|---|---|
| | | precipitate | formic acid | stirring | | | | recovery | | recovery |
| | | with or | concentration | speed | temperature | D50 | | rate (%) | | rate (%) |
| Method | pH | without | (mol/L) | (rpm) | (° C.) | (μm) | filterability | Ni | Co | Li |
| A1 | 3 | with | 0.3 | 250 | 85 | 5.3 | favorable | 91.2 | 93.0 | 94.3 |
| A2 | 3 | with | 0.5 | 450 | 90 | 5.8 | favorable | 92.5 | 91.2 | 93.6 |
| A3 | 5 | with | 0.3 | 250 | 85 | 6.3 | favorable | 91.5 | 93.3 | 95.1 |
| A4 | 3 | with | 1.0 | 650 | 95 | 2.9 | not favorable | 82.2 | 84.6 | 95.2 |
| A5 | 5 | with | 1.0 | 650 | 95 | 2.6 | not favorable | 82.4 | 83.4 | 94.2 |
| B1 | 6 | without | 0.3 | 250 | 85 | — | — | — | — | — |

### Example 2

The separation operation was performed in the same manner as in Example 1, except that, in the first step, the concentration of the aqueous formic acid solution, the stirring speed, and the water temperature were controlled as shown in Table 1, and the same evaluation was performed. The results are shown in Table 1. The D50 of the resultant precipitate was 5.8 μm, which was sufficiently large, indicating that the filterability was favorable.

### Example 3

The separation operation was performed in the same manner as in Example 1, except that, in the first step, the aqueous formic acid solution was added dropwise until the pH of the first solution reached pH=5, and the same evaluation was performed. The results are shown in Table 1. The D50 of the resultant precipitate was 6.3 μm, which was sufficiently large, indicating that the filterability was favorable.

### Example 4

The separation operation was performed in the same manner as in Example 1, except that, in the first step, the concentration of the aqueous formic acid solution, the stirring speed, and the water temperature were controlled as shown in Table 1, and the same evaluation was performed. The results are shown in Table 1. The D50 of the resultant precipitate was small, indicating that favorable filterability was not obtained.

### Example 5

The separation operation was performed in the same manner as in Example 4, except that, in the first step, the aqueous formic acid solution was added dropwise until the pH of the first solution reached pH=5, and the same evaluation was performed. The results are shown in Table 1. The D50 of the resultant precipitate was small, indicating that favorable filterability was not obtained.

### Comparative Example 1

In the first step, the aqueous formic acid solution was added dropwise until the pH of the water reached pH=6. Nothing precipitated even after 3 days.

Table 1 shows that, in Examples 1 to 5, the transition metal (M) recovery rate and the Li recovery rate both exceeded 90%. It would be understood that the D50 of the precipitate can be controlled within a desired range, depending on the conditions in the step of obtaining a slurry.

### INDUSTRIAL APPLICABILITY

The method of separating a transition metal and Li from a compound containing Li and the transition metal according to the present disclosure is particularly useful as a recycling process for electrode materials of secondary batteries. The method is low in processing cost, has small impact on environment, and is excellent in economic rationality.

1. A method for separating a transition metal and Li, comprising:
a step of allowing a compound containing Li and a transition metal to react with a carboxylic acid in water, to obtain a slurry containing a first solution containing Li ions and a precipitate containing a transition metal carboxylate; and
a step of separating the precipitate from the first solution, wherein
the transition metal is at least one selected from the group consisting of Ni, Co, Mn, Ti, Fe, and Cu.

2. The method for separating a transition metal and Li according to claim 1, wherein a pH of the first solution is 5 or less.

3. The method for separating a transition metal and Li according to claim 1, wherein the precipitate is allowed to precipitate so that a median diameter at 50% cumulative volume in a volume-based particle size distribution reaches 4 μm or more.

4. The method for separating a transition metal and Li according to claim 1, wherein in the step of obtaining a slurry, the precipitate is allowed to precipitate while the compound containing Li and a transition metal is stirred at 200 to 500 rpm, in water at 90° C. or less.

5. The method for separating a transition metal and Li according to claim 1, wherein in the step of obtaining a slurry, the carboxylic acid is added, in a form of an aqueous carboxylic acid solution having a concentration of 0.2 mol/L to 0.6 mol/L, to the compound containing Li and a transition metal in the water.

6. The method for separating a transition metal and Li according to claim 1, wherein the compound containing Li and a transition metal is a composite metal oxide containing Li and a transition metal.

7. The method for separating a transition metal and Li according to claim 1, wherein the compound containing Li and a transition metal is an electrode material recovered from a secondary battery.

8. The method for separating a transition metal and Li according to claim 1, further comprising a step of purifying the first solution with an ion-exchange resin, to obtain a high-concentration Li solution.

9. The method for separating a transition metal and Li according to claim 1, wherein formic acid is used as the carboxylic acid.

10. The method for separating a transition metal and Li according to claim 1, wherein a Li recovery rate as a percentage expressed by C1×100 is 85% or more, where the C1 is a value obtained by dividing an Li amount in the first solution by a sum of the Li amount in the first solution and a Li amount in the precipitate.

11. The method for separating a transition metal and Li according to claim 1, wherein a transition metal recovery rate as a percentage expressed by C2×100 is 80% or more, where the C2 is a value obtained by dividing a transition metal amount in the precipitate by a sum of a transition metal amount in the first solution and the transition metal amount in the precipitate.
